(19) United States
(12) Patent Application Publication
(10) Pub. No.: US 2006/0101649 A1
(43) Pub. Date: May 18, 2006

(54) Knife with spaced ceramic tips

(76) Inventor: Chen Fen Chen, Nantou (TW)

Correspondence Address: Chen, Chen Fen, Xiny i District, 9F., No. 37 Dongsing Road, Taipei City, 110, TW

(21) Appl. No.: 10/988,128

(22) Filed: Nov. 15, 2004

(51) Int. Cl. B26B 9/00

(52) U.S. Cl. 30/349

(57) ABSTRACT

A knife includes a handle and a blade connected to an end of the handle. The blade is formed at one side for forming a cutting edge with a plurality of spaced connecting elements to define a space between any two adjacent connecting elements. A ceramic tip is firmly set in each space. Outer ends of the ceramic tips and the connecting elements are flush with one another and formed into the cutting edge of the blade. With the ceramic tips, the knife has a blade with increased wear strength and could be mass-produced at reduced cost.

### FIELD OF THE INVENTION

The present invention relates to a knife, and more particularly to a knife having a blade with increased wear strength and allowing mass production at reduced cost.

### BACKGROUND OF THE INVENTION

Conventional knives are generally made of a stainless steel material by way of forging at high temperature. The forged stainless steel knife has a sharp and thin edge that facilitates easy cutting but has insufficient hardness and wear strength. Dents tend to appear on the edge of the stainless steel blade after the knife has been used for a prolonged time, making the blade blunt and no longer suitable for cutting.

A ceramic knife having a blade made of precision ceramic material has been developed in an attempt to overcome the disadvantages existed in the conventional stainless steel knife. The blade of the ceramic knife is made of ceramic powder by way of injection molding or die casting, and therefore requires very high material cost. The ceramic knife also has relatively high manufacturing cost because it is uneasy to process the blade, particularly for a big-size ceramic knife. Any small defect appeared in the course of manufacture would result in a completely unacceptable knife. While the blade of the ceramic knife has the advantage of high wear strength, it tends to crack or break on impact or falling due to a relatively high hardness thereof. Therefore, the ceramic knife is not so practical for use.

### SUMMARY OF THE INVENTION

A primary object of the present invention is to provide a knife having a blade provided with spaced ceramic tips, so that the blade has increased wear strength and the knife could be mass-produced at reduced cost.

To achieve the above and other objects, the knife according to the present invention includes a handle and a blade connected to an end of the handle. The blade is formed at one side for forming a cutting edge with a plurality of spaced connecting elements to define a space between any two adjacent connecting elements. A ceramic tip is firmly set in each of the spaces. Outer ends of the ceramic tips and the connecting elements are flush with one another and formed into the cutting edge of the blade of the knife.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a knife according to a first embodiment of the present invention;

FIG. 1A is an enlarged view of the circled area in FIG. 1;

FIG. 2 is an assembled perspective view of FIG. 1;

FIG. 3 is a cross sectional view of FIG. 2;

FIG. 4 is a partially exploded perspective view of a knife according to a second embodiment of the present invention;

FIG. 5 is an assembled perspective view of FIG. 4; and

FIG. 6 is a fragmentary cross sectional view of FIG. 5.

### DETAILED DESCRIPTION OF THE PREFERRED EMBODIMENTS

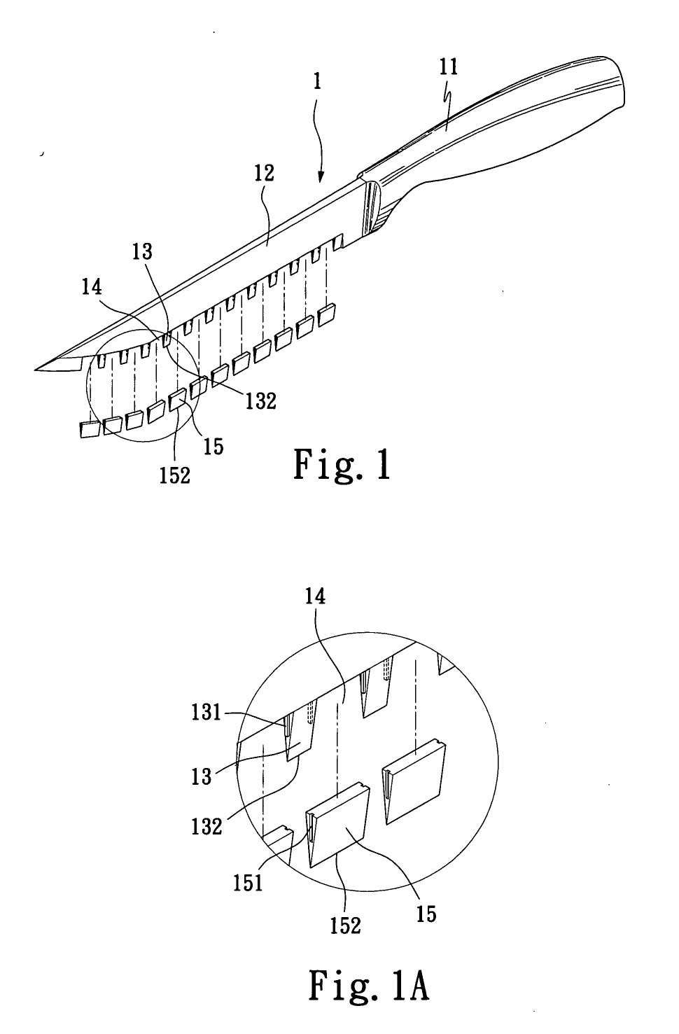

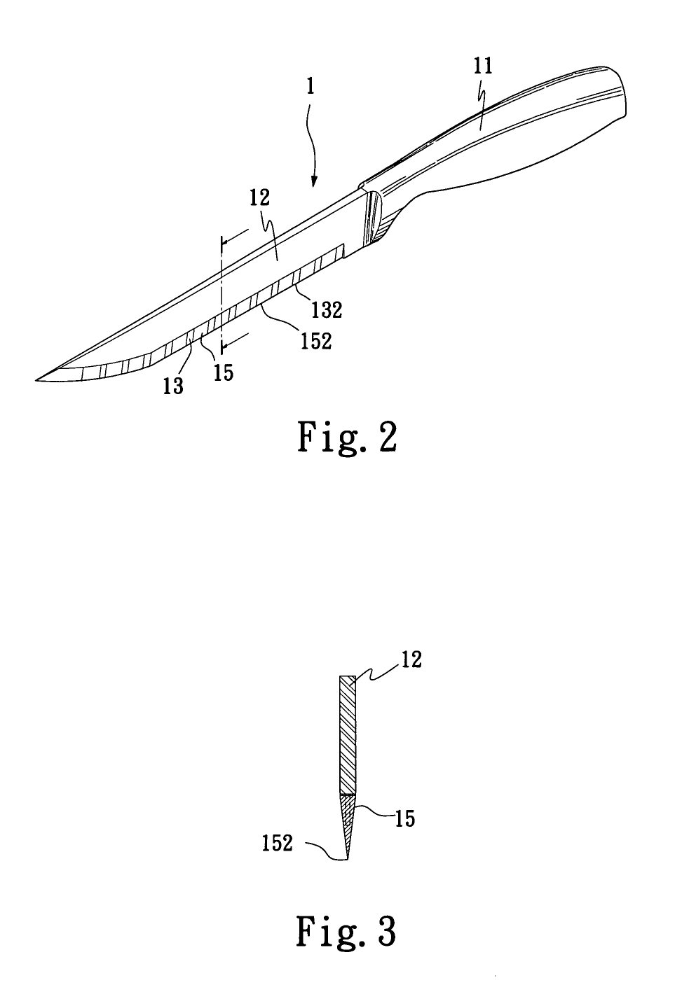

Please refer to FIGS. 1 and 2 that are exploded and assembled perspective views, respectively, and to FIG. 3 that is a cross sectional view of a knife 1 according to a first embodiment of the present invention. As shown, the knife 1 mainly includes a handle 11, and a blade 12 connected to and forward extended from an end of the handle 11.

The blade 12 may be made of a stainless steel material or a plastic steel material, and is provided at one side for forming a cutting edge of the knife 1 with a plurality of spaced connecting elements 13. As can be clearly seen from FIG. 1A that is an enlarged view of the circled area of FIG. 1, each of the connecting elements 13 has an outer end forming a cutting edge 132, and is provided at two lateral ends with a guide rail 131 each.

A space 14 is defined between two adjacent connecting elements 13 for a ceramic tip 15 to set therein. Each of the ceramic tips 15 has an outer end forming a cutting edge 152 and is provided at two lateral ends with a groove 151 each corresponding to the guide rail 131 on the connecting element 13, such that the ceramic tips 15 are firmly set in the spaces 14 with the grooves 151 engaged with the guide rails 131 and the cutting edges 152 flush with the cutting edges 132. Moreover, a heat-resistant bonding agent may be used to further bond the ceramic tips 15 to the connecting elements 13, so that the ceramic tips 15 are immovably set in the spaces 14.

With the ceramic tips 15, the blade 12 of the knife 1 has increased wearing strength and is not easily worn out due to cutting. Moreover, the knife 1 could be mass-produced at largely reduced manufacturing cost through combination of the ceramic tips 15 with the connecting elements 13 and the spaces 14. And, the ceramic tips 15 could be advantageously applied to different types of knives.

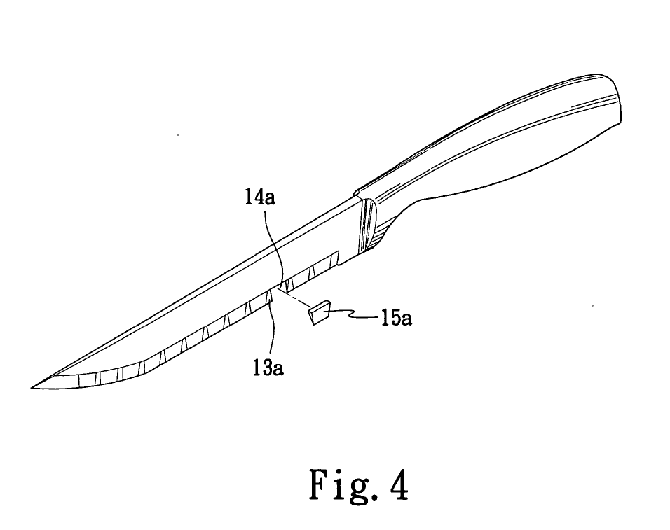

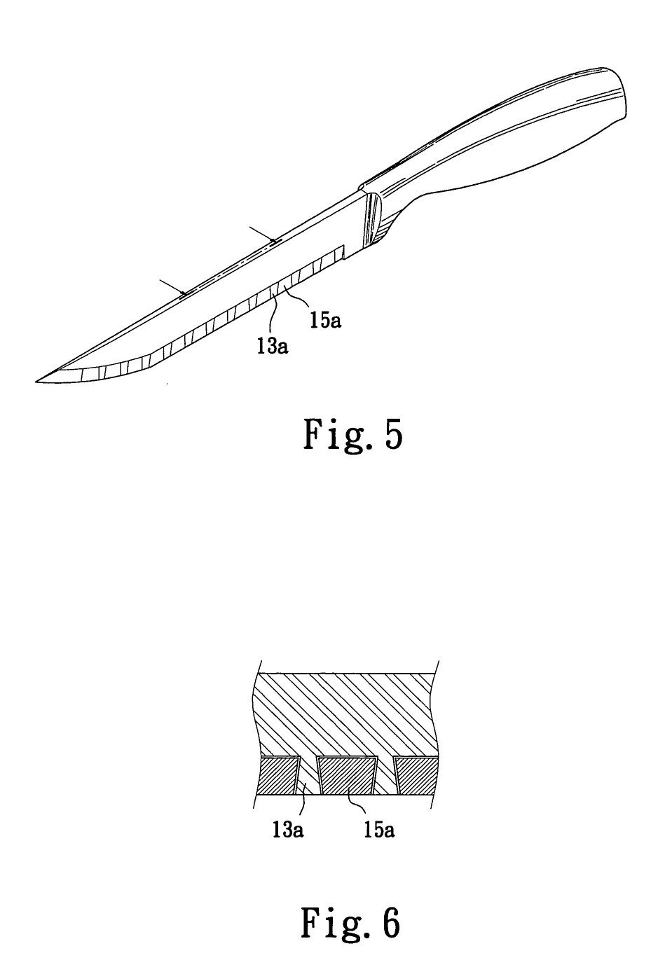

Please refer to FIGS. 4 and 5 that are exploded and assembled perspective views, respectively, and to FIG. 6 that is a cross sectional view of a knife according to a second embodiment of the present invention. As shown, the knife in the second embodiment of the present invention is generally similar to that in the first embodiment, except that it includes a plurality of spaced connecting elements 13a having two upward tapered lateral ends and accordingly, a plurality of spaces 14a having an inner end wider than an outer end thereof. To match the spaces 14a, the knife of the second embodiment includes a plurality of ceramic tips 15a having two downward tapered lateral ends and accordingly, an inner end wider than an outer end thereof to correspond to the spaces 14a. With these arrangements, the ceramic tips 15a may be tightly set in the spaces 14a by way of drive fit. As in the first embodiment, the connecting elements 13a and the ceramic tips 15a may be further bonded to each other using a heat-resistant bonding agent to ensure immovable setting of the ceramic tips 15a in the spaces 14a.

In brief, the knife of the present invention is characterized in the provision of a plurality of spaced ceramic tips that provide the blade of the knife with increased wear strength and enable mass production of the knife at largely reduced cost, making the knife of the present invention more practical for use.

What is claimed is:

1. A knife comprising a handle and a blade connected to and extended from an end of said handle; said knife being characterized in that said blade is formed at one side for forming a cutting edge with a plurality of spaced connecting elements to define a space between two said connecting elements that are adjacent to each other, that a ceramic tip is set in each said space, and that both said ceramic tips and said connecting elements have outer ends flush with one another to form said cutting edge of said blade.

2. The knife as claimed in claim 1, wherein said blade is made of a stainless steel material.

3. The knife as claimed in claim 1, wherein said blade is made of a plastic steel material.

4. The knife as claimed in claim 1, wherein each of said connecting elements is provided at two lateral ends with a guide rail each, and each of said ceramic tips is provided at two lateral ends with a groove each corresponding to said guide rail on said connecting element, such that said guide rails are set in said grooves when said ceramic tips are set in said spaces between said adjacent connecting elements.

5. The knife as claimed in claim 1, wherein each of said connecting elements has two upward tapered lateral ends, and each of said spaces and each of said ceramic tips have an inner end wider than an outer end thereof, allowing said ceramic tips to set in said spaces by way of drive fit.

6. The knife as claimed in claim 1, wherein said connecting elements and said ceramic tips are further bonded to one another using a heat-resistant bonding agent to ensure immovable setting of said ceramic tips in said spaces.
